(19) United States
(12) Patent Application Publication
(10) Pub. No.: US 2023/0184561 A1
(43) Pub. Date: Jun. 15, 2023

(54) SYSTEMS AND METHODS FOR PROVIDING A MONITORING SERVICE FOR A PEDESTRIAN

(71) Applicant: Ford Global Technologies, LLC, Dearborn, MI (US)

(72) Inventors: Stuart C. Salter, White Lake, MI (US); Hussein Berry, Dearborn, MI (US); Ryan O'Gorman, Beverly Hills, MI (US); John Robert Van Wiemeersch, Novi, MI (US)

(73) Assignee: Ford Global Technologies, LLC, Dearborn, MI (US)

(21) Appl. No.: 17/547,389

(22) Filed: Dec. 10, 2021

(51) Int. Cl. G01C 21/36; G01C 21/34; B60R 25/24; B60R 25/20; B60R 25/01; B60Q 1/50; G06V 20/52; G06V 20/58; G06V 40/10; B60L 58/13

(52) U.S. Cl. CPC G01C 21/3647; G01C 21/3461; B60R 25/245; B60R 25/2018; B60R 25/01; B60Q 1/50; G06V 20/52; G06V 20/58; G06V 40/10; B60L 58/13; B60Q 2900/30

(57) ABSTRACT

The disclosure generally pertains to systems and methods for providing a monitoring service for a pedestrian. In an example method, a request for activation of a monitoring service can be received. The request can include a present location and a destination. Upon receiving the request for activation of the monitoring service, a travel route can be determined from the present location to the destination. As a traveler travels along the travel route, each of one or more vehicles along the travel route may be activated. Each of the one or more vehicles can be configured to stream at least one video feed when the traveler is proximate to the each of the one or more vehicles. The monitoring service can be terminated when the traveler has reached the destination.

### BACKGROUND

Pedestrians may travel on foot through various locations, such as sidewalks, alleys, and parking lots or parking garages. In some locations or at certain times of the day, there may be lower visibility or lower pedestrian traffic, thus resulting in pedestrians feeling discomfort as they travel through those locations on foot. For example, a pedestrian may feel more uncomfortable when traveling on foot at night than during the day because of reduced visibility of the surrounding areas at night.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example vehicle that includes a monitoring system in accordance with an embodiment of the disclosure.

FIG. 2 illustrates an example implementation of a monitoring service for a pedestrian walking on a street in accordance with an embodiment of the disclosure.

FIG. 3 illustrates an example implementation of a monitoring service for a pedestrian walking in a parking lot in accordance with an embodiment of the disclosure.

FIG. 4 depicts a flow chart of an example method for utilizing a monitoring service in accordance with the disclosure.

### DETAILED DESCRIPTION

### Overview

In terms of a general overview, certain embodiments described in this disclosure are directed to systems and methods for providing a monitoring service for a pedestrian. In an example method, a request for activation of a monitoring service can be received. The request can include a present location and a destination. Upon receiving the request for activation of the monitoring service, a travel route can be determined from the present location to the destination. As a traveler travels along the travel route, each of one or more vehicles along the travel route may be activated. Each of the one or more vehicles can be configured to stream at least one video feed when the traveler is proximate to the each of the one or more vehicles. The monitoring service can be terminated when the traveler has reached the destination.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component.

Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “traveler” may be used interchangeably with the word “user” and the word “pedestrian.” Either word as used herein refers to any individual that is utilizing the monitoring service. The word “device” may be any of various devices, such as, for example, a user device such as a smartphone or a tablet, a smart vehicle, and a computer.” The word “sensor” may be any of various sensors that can be found in a vehicle, such as cameras, radar sensors, Lidar sensors, and sound sensors.

It must also be understood that words such as “implementation,” “scenario,” “case,” and “situation” as used herein are an abbreviated version of the phrase “in an example (“implementation,” “scenario,” “case,” “approach,” and “situation”) in accordance with the disclosure.” Furthermore, the word “example” as used herein is intended to be non-exclusionary and non-limiting in nature.

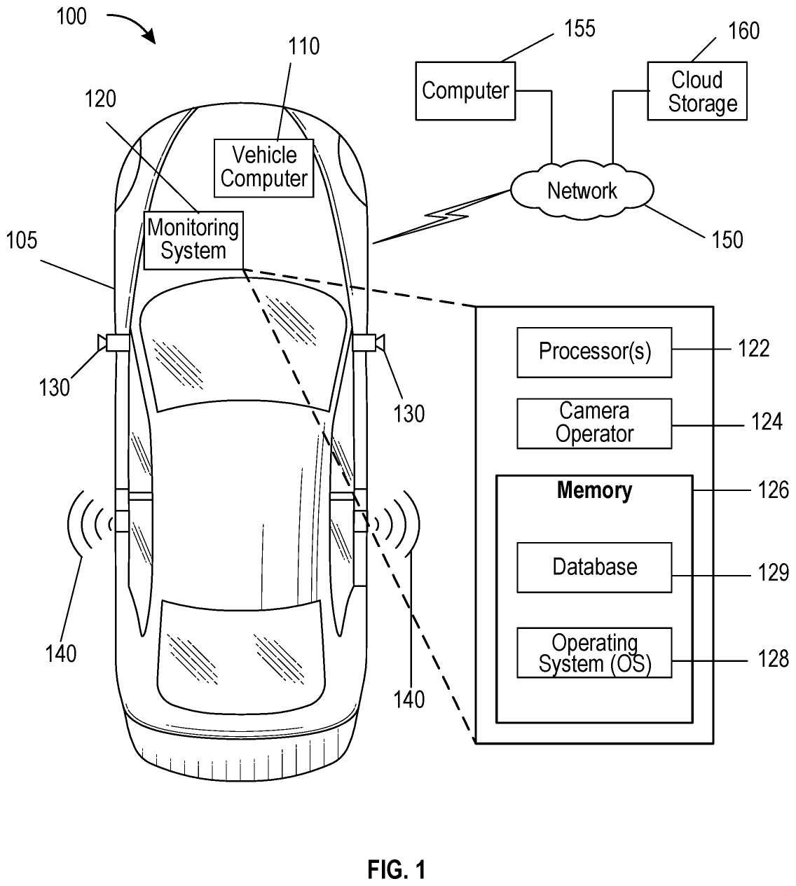

FIG. 1 illustrates an example vehicle 105 that includes a monitoring system 100 in accordance with an embodiment of the disclosure. The vehicle 105 may be any of various types of vehicles such as, for example, a gasoline powered vehicle, an electric vehicle, a hybrid electric vehicle, an autonomous vehicle, a sedan, a van, a minivan, a sports utility vehicle, a truck, a station wagon, or a bus.

The vehicle 105 may further include components such as, for example, a vehicle computer 110, a monitoring system 120, at least one camera 130, and at least one audio sensor 140. The vehicle 105 may further include various types of sensors and detectors configured to provide various functionalities. The vehicle computer 110 may perform various operations associated with the vehicle 105, such as controlling engine operations like turning the vehicle 105 on and off, fuel injection, speed control, emissions control, braking, and other engine operations. The at least one camera 130 may be mounted on any portion of the vehicle 105 and may be used for various purposes, such as, for example, to record video activity in an area surrounding the vehicle 105. In some embodiments, the at least one camera 130 may include various cameras that are already implemented on the vehicle 105, such as, for example, Advanced Driver Assistance Systems (ADAS), exterior rear-view mirrors, traffic cameras, B-Pillar cameras, and other cameras.

The at least one audio sensor 140 may be mounted on any portion of the vehicle 105 and may be used for various purposes, such as, for example, to record audio activity in an area surrounding the vehicle 105. The at least one audio sensor 140 may be provided in various forms. In one example implementation, the at least one audio sensor 140 may be provided in the form of a single microphone. In another example implementation, the audio sensor 140 may be provided in the form of multiple microphones. The multiple microphones may be components of a microphone array apparatus that may be mounted on the roof of the vehicle 105 (such as near the front windshield or above the rear-view mirror). Alternatively or in combination, the multiple microphones may be individual microphones that are mounted on various portions of the vehicle 105, such as a side pillar, a rear window, the roof, or other portions of the vehicle 105.

In some embodiments, the vehicle computer 110 and the monitoring service 115 are configured to communicate via a network 150 with devices located outside the vehicle 105, such as, for example, a computer 155 (a server computer, a cloud computer, etc.) and/or a cloud storage device 160.

The network 150 may include any one, or a combination of networks, such as, for example, a local area network (LAN), a wide area network (WAN), a telephone network, a cellular network, a cable network, a wireless network, and/or private/public networks such as the Internet. The network 150 may support any of various communications technologies, such as, for example, TCP/IP, Bluetooth®, near-field communication (NFC), Wi-Fi, Wi-Fi Direct, Ultra-Wideband (UWB), cellular, machine-to-machine communication, and/or man-to-machine communication.

In some embodiments, the monitoring system 120 may include a processor 122, a camera operator 124, and a memory 126. It must be understood that the camera operator 124 is a functional block that can be implemented in hardware, software, or a combination thereof. Some example hardware components may include an audio amplifier and a signal processor. Some example software components may include a video analysis module, a power module, and a signal processing module. The processor 122 may carry out camera operations by executing computer-readable instructions stored in the memory 126. The memory 126, which is one example of a non-transitory computer-readable medium, may be used to store an operating system (OS) 128 and may further include a database 129 for storing data.

In some embodiments, the monitoring system 120 may be configured to execute various functions associated with detecting a traveler proximate to the vehicle 105 in a circumstance where the traveler is presently utilizing a monitoring service. The monitoring system 120 may be further configured to activate the at least one camera 130 when a traveler proximate to the vehicle 105 is detected. The at least one camera 130 may then be configured to record activity in its field of view for as long as the traveler remains proximate to the vehicle 105. In an example embodiment, the monitoring system 120 may be communicatively coupled to the vehicle computer via wired and/or wireless connections. More particularly, the monitoring system 120 may be communicatively coupled to the vehicle 105 via a vehicle bus that uses a controller area network (CAN) bus protocol, a Media Oriented Systems Transport (MOST) bus protocol, and/or a CAN flexible data (CAN-FD) bus protocol. In another embodiment, the communications may be provided via wireless technologies such as Bluetooth®, Ultra-Wideband (UWB), cellular, Wi-Fi, ZigBee®, or near-field communications (NFC).

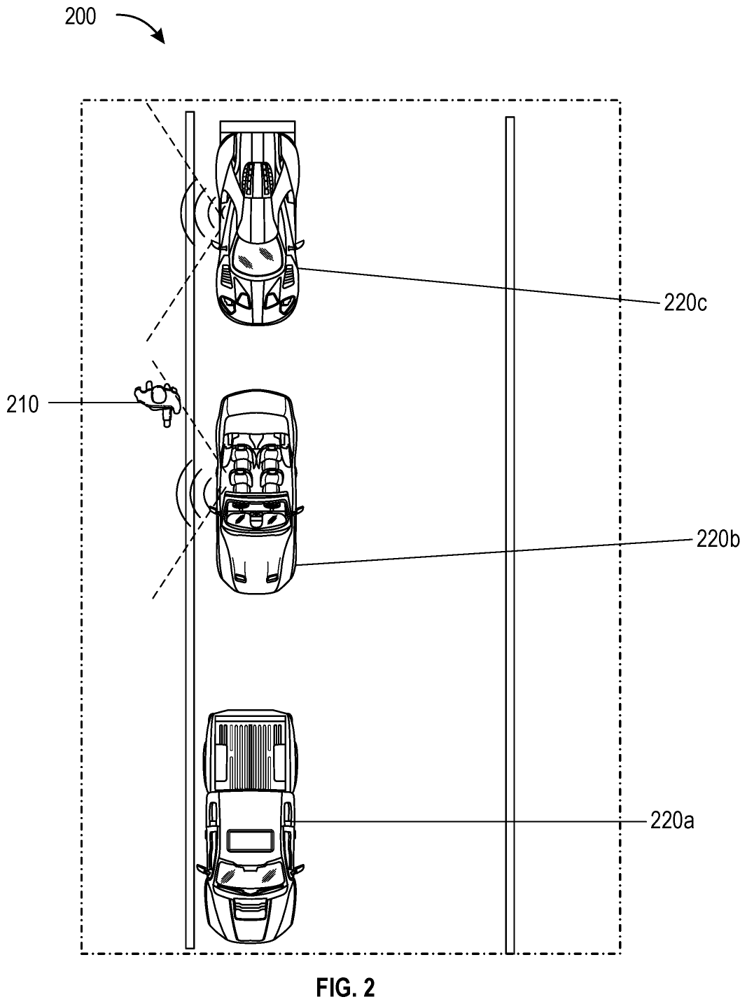

FIG. 2 illustrates an example implementation of a monitoring service 200 in accordance with an embodiment of the disclosure. A monitoring service 200 may become activated when a request for activation of the monitoring service 200 is received. In some embodiments, the monitoring service 200 may be part of a subscription service that a traveler 210 is enrolled in. A subscription service may include multiple tiers with varying levels of data processing involved. For example, a basic subscription may include video recording, while an upgraded subscription may include video and audio analysis, and a person may review the video and audio footage in real-time at the highest tier of subscriptions.

In some embodiments, the request may be received from a user device associated with the traveler 210, such as a mobile phone. In some embodiments, the request may include a present location of the traveler 210 and a destination of the traveler 210. The destination of the traveler 210 may be a landmark that the traveler 210 is seeking to reach, the location of the traveler's 210 vehicle, or any other geographic location that the traveler 210 is seeking to reach.

Once a travel route from the traveler's 210 present location to the intended destination has been determined, the traveler 210 may begin proceeding on foot from his or her present location towards the intended destination. As the traveler 210 proceeds from the present location to the destination, each of one or more vehicles 220 along the travel route may be activated for a duration of time. It should be noted that the location of the each of the one or more vehicles 220 may be made known via GPS or other known location-detection methods. Similarly, it should be noted that the location of the traveler 210 may be made known via a GPS location of the traveler's 210 mobile device or other known location-detection methods. Other known location-detection methods may include, for example, using a Bluetooth® Low Energy (BLE) signal from the traveler's 210 device. Even if the traveler's 210 device is unpaired, a location of the traveler 210 may be determined by using multiple BLE antennas on a single vehicle 220 or multiple BLE antennas on multiple vehicles 220 to trilaterate the BLE signal from the traveler's 210 device.

In some embodiments, the traveler 210 may be presented with at least two travel route options. The traveler 210 may then have the ability to select a preferred travel route from the at least two travel route options. In some instances, when the at least two travel route options are presented, each travel route option may include details regarding the vehicles along that travel route that are participating in the monitoring service 200. This may assist the traveler 210 in determining the amount of coverage and/or assistance that may be available along each travel route.

The each of the one or more vehicles 220 may become activated when the traveler 210 is detected to be proximate to the each of the one or more vehicles 220. The proximity may be based at least in part on the known locations of both the each of the one or more vehicles 220 and the traveler 210. In some instances, the traveler 210 being proximate to the each of the one or more vehicles 220 may refer to the traveler 210 being within a predetermined distance threshold from the each of the one or more vehicles 220. In some instances, the each of the one or more vehicles 220 may become activated when the traveler 210 is detected to be within a field of view of at least one camera on the each of the one or more vehicles 220. In some instances, owners of the each of the one or more vehicles 220 that are activated may be compensated for use of their vehicle in the monitoring service 200. Additionally, surrounding cameras may also be configured to be activated if the traveler 210 is detected to be proximate to those surrounding cameras. For example, the monitoring service 200 may be further enhanced by activating, for example, business security cameras, parking structure cameras, and cameras on other public transportation vehicles in the surrounding area, to provide additional coverage. In such instances, owners of the surrounding cameras that are activated may be compensated for use of their cameras in the monitoring service 200.

When the each of the one or more vehicles 220 is activated, the at least one camera and the at least one audio sensor on the each of the one or more vehicles 220 may be configured to record video and audio activity respectively. Alternatively, or in combination, when the each of the one or more vehicles 220 has become activated, the at least one camera and the at least one audio sensor on the each of the one or more vehicles 220 may be configured to stream video and audio activity respectively. The video feed and audio feed that is obtained from the at least one camera and the at least one audio sensor may be transmitted to and stored in a computer and/or a cloud server. In some embodiments, the traveler 210 may further opt to have the video feed and audio feed stored at the computer and/or the cloud server for a predetermined period of time.

In some embodiments, exterior projectors, such as vehicle windows or projector puddle lamps, may display live video feed from the at least one camera so that other pedestrians in the area may be on notice that the area is under surveillance. Alternatively, or in combination, a sound exciter may be implemented in each of the one or more vehicles 220 to indicate that the area is under surveillance. To do so, the sound emitter may emit a series of beeps or chirps, or it may play a pre-recorded announcement that the area is under surveillance.

In addition to recording and/or streaming video and audio activity, when the each of the one or more vehicles 220 is activated, the each of the one of more vehicles 220 may be configured to turn on the vehicle's 220 headlights or taillights in order to provide additional illumination for the traveler as the traveler 210 proceeds from the present location to the destination. Other vehicle lights may further be configured to turn on in such circumstances, in addition to headlights or taillights. It should be noted that, when the each of the one or more vehicles 220 is activated, the brightness of each light may vary based upon environmental circumstances, such as the time of day and the presence of cars in front of the vehicle 220. For example, the vehicle's lights may be configured to flash during the day instead of remaining on for a period of time. Alternatively, headlights of the vehicle 220 may be configured to be dimmer when other vehicles are parked in front of the vehicle 220.

In some embodiments, if a dangerous situation is detected, one of the activated vehicles 220 may be configured to unlock in order to allow the traveler 210 to shelter inside the activated vehicle 220. Once the traveler 210 has entered the activated vehicle 220, the activated vehicle 220 may be re-locked in order to protect the traveler 210 from the dangerous situation.

In other embodiments, the streamed video and audio activity may be reviewed in real time as long as the monitoring service remains activated. In certain embodiments, the streamed video and audio activity may be reviewed by a person, for example, a security guard. In such embodiments, the person reviewing the streamed video and audio activity may be capable of communicating a warning to the traveler in the event that he or she detects a dangerous situation. For example, this communication may be done via sound exciters, and a security guard may be able to speak to and hear from the traveler 210 and anyone that may put the traveler 210 in a dangerous situation.

In some embodiments, facial recognition techniques may be applied such that artificial intelligence and machine learning methods can be used to determine facial identification of a person, a vehicle, or a landmark. This may assist the monitoring service 200 in verifying the current location and direction of travel of the traveler 210. The facial identification process may occur at the each of the one or more vehicles 220. In other embodiments, geolocation techniques may be applied as the traveler 210 proceeds along the travel route to further verify the current location and direction of travel of the traveler 210. In some embodiments, the each of the one or more vehicles 220 may be stationary when activated. In other embodiments, the each of the one or more vehicles 220 may be in motion when activated, such as, for example, while the vehicle 220 is traveling slowly, when the vehicle 220 is stopped at a traffic light, when the vehicle 220 is passing the traveler 210, or when the vehicle 220 is turning a corner.

In some embodiments, a camera integrator may be included in order to integrate video and audio feed from multiple cameras and audio sensors. The camera integrator may take each vehicle 220's direction and the direction of travel of the traveler 210 into account when processing a preferred view of the surrounding area. For example, an entry camera may be located only on the driver's door, which renders video feed at the entry camera lacking a sidewalk view unless the road is narrow and traffic is moving in an opposite direction from the vehicle 220. Similarly, front cameras are unlikely to be able to get a front view of the traveler 210 if the traveler 210 is presently located behind the front camera.

It should further be noted that such monitoring services 200 may be implemented on other forms of transportation, including subways, buses, and airplanes.

In some embodiments, prior to activating the each of the one or more vehicles 220, a battery charge level of the each of the one or more vehicles 220 may be evaluated to ensure that the battery charge level is greater than a predetermined threshold battery charge level. More specifically, a power consumption per hour of active monitoring may be determined for each of the one or more vehicles 220 and the applicable sensors on that vehicle 220. An estimated total power consumption may then be calculated for each of the one or more vehicles 220. Only if the present battery charge level is greater than the predetermined threshold battery charge level, which may include the amount of battery charge needed for active monitoring in addition to a predetermined amount of minimum battery charge to be held by the battery, will a vehicle 220 be configured to be activated when the traveler 210 is proximate to the vehicle 220. In some embodiments, if a vehicle 220 has a present battery charge level below the predetermined threshold battery charge level, the vehicle 220 may still be configured for activation if charging options are available at its location and the vehicle 220 is configured for electric charging. In some embodiments, if a vehicle 220 is an internal combustion engine (ICE) vehicle or a hybrid vehicle, and the vehicle 220 has a present battery charge level below the predetermined threshold battery charge level, the vehicle 220 may still be configured for activation if the vehicle 220 has remote start capabilities in order to turn the vehicle 220 on and charge the battery in the vehicle 220. This prevents vehicles 220 from being activated when a battery charge level is deemed to be too low to support active monitoring of a pedestrian.

In some embodiments, the each of the one or more vehicles 220 may automatically de-activate when the traveler 210 is detected to be outside of a predetermined range of the each of the one or more vehicles 220. In other embodiments, the each of the one or more vehicles 220 may only de-activate when the traveler 210 has terminated the monitoring service 200.

As depicted in FIG. 2, as the traveler 210 proceeds down a sidewalk, the vehicles 220 that are parked on the side of the street and are proximate to the traveler 210 are activated as the traveler becomes proximate to each of the vehicles 220. However, the traveler 210 may not always be within the field of view of an available camera. For example, as depicted in FIG. 2, the traveler 210 may be too far from a first vehicle 220a. Thus, the first vehicle 220a may not be activated. The traveler 210 may be proximate to a second vehicle 220b and a third vehicle 220c. For example, the traveler 210 may be within a predetermined distance threshold from each of the second vehicle 220b and the third vehicle 230c. However, while both the second vehicle 220b and the third vehicle 230c may be activated, the traveler 210 may only be visible in video feed from the camera mounted to the second vehicle 220b. This may be because the traveler 210 may be within the field of view of cameras on the second vehicle 220b, but the traveler 210 may not be visible in video feed from cameras mounted to the third vehicle 220c because the traveler 210 may be outside of the field of view of cameras on the third vehicle 220c.

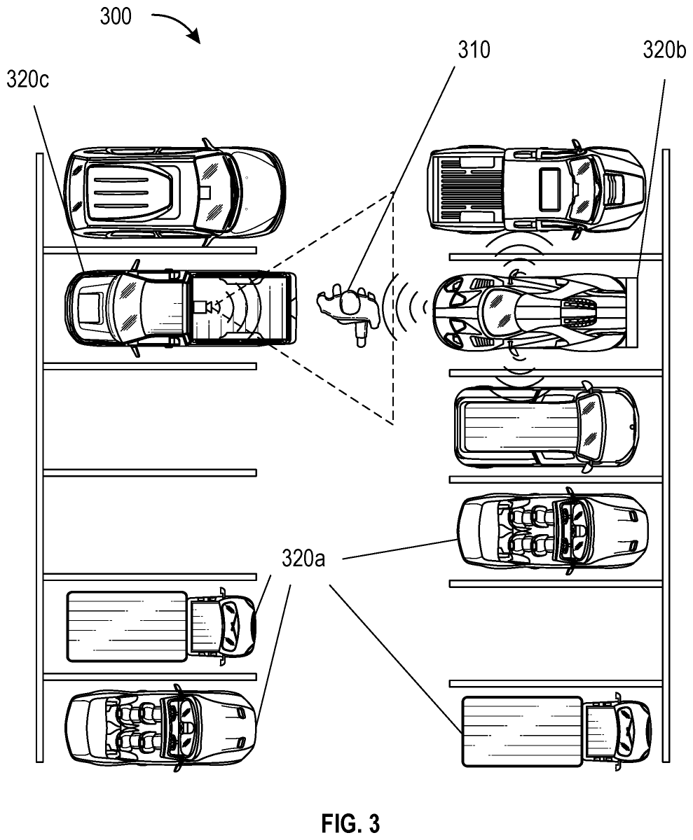

FIG. 3 depicts an example implementation for a monitoring service 300 in accordance with the disclosure. In some instances, the monitoring service 300 may involve a traveler 310 proceeding through a parking lot or garage. In some instances, vehicles 320a that are not proximate to traveler 310 may not be activated. For example, vehicles 320a may be outside of a predetermined distance threshold from the traveler 310.

In some instances, all audio sensors on a vehicle 320b that is proximate to the traveler 310 may be configured for activation. This may include the audio sensors on the vehicle 320b that may not directly face the traveler 310. In contrast, cameras may be selectively activated in order to ensure that the final video feed is preferred by reviewing users. For example, if a truck 320c has a truck bed camera having a field of view that includes the traveler 310 and the truck 320c's rear is proximate to the traveler 310, the truck bed camera may be identified as having the preferred camera angle and may therefore be activated, instead of other cameras on the truck 320c, when the traveler 310 is proximate to the truck 320c.

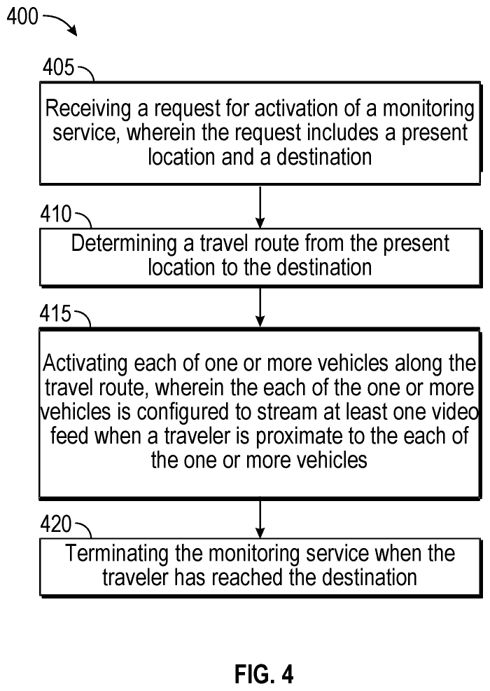

FIG. 4 shows a flow chart 400 of an example method of utilizing a monitoring service in accordance with the disclosure. The flow chart 400 illustrates a sequence of operations that can be implemented in hardware, software, or a combination thereof. In the context of software, the operations represent computer-executable instructions stored on one or more non-transitory computer-readable media such as a memory 126 provided in the monitoring system 120, that, when executed by one or more processors such as the processor 122 provided in the monitoring system 120, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flow chart 400 may be carried out by the monitoring system 120 either independently or in cooperation with other devices such as, for example, the vehicle computer 110, the at least one camera 130, the at least one audio sensor 140, and cloud elements (such as, for example, the computer 155 and cloud storage device 160).

At block 405, a request for activation of a monitoring service may be received. In some embodiments, the request may be received from a user device associated with a traveler, such as a mobile phone. In some embodiments, the request may include a present location of the traveler and a destination of the traveler. The destination of the traveler may be a landmark that the traveler is seeking to reach, the location of the traveler's vehicle, or any other geographic location that the traveler is seeking to reach.

At block 410, a travel route from the present location to the destination is determined. The travel route may be configured for the traveler to walk on foot from the present location to the destination. In some optional embodiments, at least two travel routes from the present location to the destination may be determined. In such embodiments, the traveler may select a preferred travel route from among the at least two travel routes.

At block 415, as the traveler proceeds from the present location to the destination, each of one or more vehicles along the travel route may be activated for a duration of time. Each of the one or more vehicles may become activated when the traveler is detected to be proximate to the each of the one or more vehicles. In some instances, the each of the one or more vehicles may become activated when the traveler is detected to be within a predetermined distance threshold from the each of the one or more vehicles. In some instances, the each of the one or more vehicles may become activated when the traveler is detected to be within a field of view of at least one camera on the each of the one or more vehicles. When the each of the one or more vehicles has become activated, the at least one camera and the at least one audio sensor on the each of the one or more vehicles may be configured to record video and audio activity respectively. Alternatively, when the each of the one or more vehicles has become activated, the at least one camera and the at least one audio sensor on the each of the one or more vehicles may be configured to stream video and audio activity respectively. In some embodiments, the each of the one or more vehicles may automatically de-activate when the traveler is detected to be outside of a predetermined range of the each of the one or more vehicles. In other embodiments, the each of the one or more vehicles may only de-activate when the traveler has terminated the monitoring service.

In addition to recording and/or streaming video and audio activity, when the each of the one or more vehicles is activated, the each of the one of more vehicles may be configured to turn on the vehicle's headlights, taillights, or other vehicle lights in order to provide additional illumination for the traveler as the traveler proceeds from the present location to the destination. In some embodiments, if a dangerous situation is detected, one of the activated vehicles may be configured to unlock in order to allow the traveler to shelter inside the activated vehicle. In other embodiments, the streamed video and audio activity may be reviewed in real time as long as the monitoring service remains activated. In certain embodiments, the streamed video and audio activity may be reviewed by a person, for example, a security guard. In such embodiments, the person reviewing the streamed video and audio activity may be capable of communicating a warning to the traveler in the event that he or she detects a dangerous situation.

In some embodiments, prior to activating the each of the one or more vehicles, a battery charge level of the each of the one or more vehicles is evaluated to ensure that the battery charge level is greater than a predetermined threshold battery charge level. Only if the battery charge level is greater than the predetermined threshold battery charge level will a vehicle be configured to be activated when the traveler is proximate to the vehicle. This prevents vehicles from being activated when a battery charge level is deemed to be too low to support active monitoring of a pedestrian.

At block 420, the monitoring service may be terminated. This may occur when the traveler manually terminates the monitoring service, or it may automatically terminate when the traveler is detected to have reached his or her destination. The traveler may be able to configure the monitoring service to terminate in accordance with the traveler's preferences.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 122, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 126, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey the information that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving a request for activation of a monitoring service, wherein the request includes a present location and a destination;
determining a travel route from the present location to the destination;
activating each of one or more vehicles along the travel route, wherein the each of the one or more vehicles is configured to stream at least one video feed when a traveler is proximate to the each of the one or more vehicles; and
terminating the monitoring service when the traveler has reached the destination.

2. The method of claim 1, wherein the each of the one or more vehicles is further configured to turn on lights proximate to the each of the one or more vehicles when the traveler is proximate to the each of the one or more vehicles.

3. The method of claim 1, wherein at least one vehicle of the one or more vehicles is further configured to unlock to allow the traveler to shelter inside the at least one vehicle in a dangerous situation.

4. The method of claim 1, wherein the traveler is actively monitored by a security guard when the monitoring service is activated.

5. The method of claim 4, wherein a warning is configured to be communicated to the traveler by the security guard in a dangerous situation.

6. The method of claim 1, further comprising:
determining that a battery charge level of the each of the one or more vehicles is greater than a predetermined threshold; and
activating the each of the one or more vehicles along the travel route, wherein the each of the one or more vehicles is further configured to stream the at least one video feed when the traveler is proximate to the each of the one or more vehicles if the battery charge level of the each of the one or more vehicles is greater than the predetermined threshold.

7. The method of claim 1, further comprising:
determining at least two travel routes from the present location to the destination;
receiving a selection of a first travel route of the at least two travel routes; and
activating the each of the one or more vehicles along the first travel route, wherein the each of the one or more vehicles is further configured to stream the at least one video feed when the traveler is proximate to the each of the one or more vehicles.

8. A device, comprising:
at least one memory device that stores computer-executable instructions; and
at least one processor configured to access the at least one memory device, wherein the at least one processor is configured to execute the computer-executable instructions to:
receive a request for activation of a monitoring service, wherein the request includes a present location and a destination;
determine a travel route from the present location to the destination;
activate each of one or more vehicles along the travel route, wherein the each of the one or more vehicles is configured to stream at least one video feed when a traveler is proximate to the each of the one or more vehicles; and
terminating the monitoring service when the traveler has reached the destination.

9. The device of claim 8, wherein the each of the one or more vehicles is further configured to turn on lights proximate to the each of the one or more vehicles when the traveler is proximate to the each of the one or more vehicles.

10. The device of claim 8, wherein at least one vehicle of the one or more vehicles is further configured to unlock to allow the traveler to shelter inside the at least one vehicle in a dangerous situation.

11. The device of claim 8, wherein the traveler is actively monitored by a security guard when the monitoring service is activated.

12. The device of claim 11, wherein a warning is configured to be communicated to the traveler by the security guard in a dangerous situation.

13. The device of claim 8, wherein the computer-executable instructions further comprise computer-executable instructions to:
determine that a battery charge level of the each of the one or more vehicles is greater than a predetermined threshold; and
activate the each of the one or more vehicles along the travel route, wherein the each of the one or more vehicles is further configured to stream the at least one video feed when the traveler is proximate to the each of the one or more vehicles if the battery charge level of the each of the one or more vehicles is greater than the predetermined threshold.

14. The device of claim 8, wherein the computer-executable instructions further comprise computer-executable instructions to:
determine at least two travel routes from the present location to the destination;
receive a selection of a first travel route of the at least two travel routes; and
activate the each of the one or more vehicles along the first travel route, wherein the each of the one or more vehicles is further configured to stream the at least one video feed when the traveler is proximate to the each of the one or more vehicles.

15. A non-transitory computer-readable medium storing computer-executable instructions which, when executed by a processor, cause the processor to perform operations comprising:
receiving a request for activation of a monitoring service, wherein the request includes a present location and a destination;
determining a travel route from the present location to the destination;
activating each one or more vehicles along the travel route, wherein the each of the one or more vehicles is configured to stream at least one video feed when a traveler is proximate to the each of the one or more vehicles; and
terminating the monitoring service when the traveler has reached the destination.

16. The non-transitory computer-readable medium of claim 15, wherein the each of the one or more vehicles is further configured to turn on lights proximate to the each of the one or more vehicles when the traveler is proximate to the each of the one or more vehicles.

17. The non-transitory computer-readable medium of claim 15, wherein at least one vehicle of the one or more vehicles is further configured to unlock to allow the traveler to shelter inside the at least one vehicle in a dangerous situation.

18. The non-transitory computer-readable medium of claim 15, wherein the traveler is actively monitored by a security guard when the monitoring service is activated.

19. The non-transitory computer-readable medium of claim 18, wherein a warning is configured to be communicated to the traveler by the security guard in a dangerous situation.

20. The non-transitory computer-readable medium of claim 15, wherein activating the each of the one or more vehicles further comprises:
determining that a battery charge level of the each of the one or more vehicles is greater than a predetermined threshold; and
activating the each of the one or more vehicles along the travel route, wherein the each of the one or more vehicles is further configured to stream the at least one video feed when the traveler is proximate to the each of the one or more vehicles if the battery charge level of the each of the one or more vehicles is greater than the predetermined threshold.
